(19) United States
(12) Patent Application Publication
(10) Pub. No.: US 2007/0011300 A1
(43) Pub. Date: Jan. 11, 2007

(54) Monitoring method and system for monitoring operation of resources

(76) Inventors: Robert J. Hollebeek, Berwyn, PA (US); Donald Li, Eagleville, PA (US)

Correspondence Address: RATNERPRESTIA, P O BOX 980, VALLEY FORGE, PA, 19482-0980, US

(21) Appl. No.: 11/178,966

(22) Filed: Jul. 11, 2005

(51) Int. Cl. G06F 15/173

(52) U.S. Cl. 709/224

(57) ABSTRACT

A monitoring system for monitoring operation of resources may include a plurality of processors, respective processors each performing reconfigurable tasks and providing log information including a respective status of the tasks. The system may further include log senders for sending the log information from respective nodes, each node being one of the processors, or an instance on a processor executing a respective task, log receivers for receiving the log information from respective log senders, a task monitor for monitoring the status of respective tasks from each processor, and a monitoring station for displaying completion information from the task monitor that indicates either successful or unsuccessful completion of a respective task being performed. The system may also include a formatter for formatting log information in a common format and a display for displaying processor/task icons indicating status of corresponding processors and tasks.

### FIELD OF THE INVENTION

The present invention relates to the field of system monitoring and, more particularly, to a method and system for monitoring operation of resources.

### BACKGROUND OF THE INVENTION

As distributed systems increase in complexity, a need arises to provide a monitoring system capable of monitoring and managing these distributed elements. When the distributed system is large and has a variety of diverse capabilities, there may exist a variety of distributed processors performing a variety of tasks (i.e., processes and sub-processes), which may be reconfigurable. Such processors\tasks may produce a large number of differently formatted log files from distributed locations containing log information pertinent for the monitoring of the system.

Conventionally, network monitoring systems monitor communications to assert the operation of the network. Such network monitoring systems are capable of determining network failures by reading and interpreting a fixed number of differently formatted logs.

What is needed, for example, is: (1) a monitoring system which monitors distributed elements (i.e., processors, tasks and communication channels between these processors; (2) a common log format which enables user settable levels-of-detail for display of the log information at the monitoring station; (3) a graphical user interface (GUI) which accommodates either user-enabled or automatic changes to the display of the log information at a monitoring station.

### SUMMARY OF THE INVENTION

The invention may be embodied as a monitoring system, a method or a computer readable carrier for monitoring operation of resources. The resources may include a plurality of processors, respective processors each performing a plurality of reconfigurable tasks and providing log information including at least a respective status of the task. The system may include a plurality of log senders for sending the log information from respective nodes, each node being either one of the processors, or an instance on one of the processors executing a respective task, a plurality of log receivers for receiving the log information from respective log senders, one or more task monitors for monitoring the status of respective tasks from each processor via the plurality of log receivers to determine at least whether the respective tasks are successfully completed, and a monitoring station for displaying completion information from the one or more task monitors that indicates either successful or unsuccessful completion of a respective one or respective ones of the tasks being performed.

The invention may be further embodied as a monitoring system, a method or a computer readable carrier for monitoring operation of resources. The resources may include a plurality of processors, respective processors having logs that include different log formats. The system may include a plurality of loggers for logging log information of each transaction in a respective one or ones of the logs, each transaction being a completion of a task and/or a condition to be monitored, a log formatter for formatting the respective one or ones of the logs for each processor into a common format, a log accumulator for accumulating logs from respective processors, and a monitoring station for receiving logs in the common format and displaying the log information thereon.

The invention may be further embodied as a display or a method for monitoring operation of resources. The resources may include a plurality of processors, respective processors each performing a plurality of reconfigurable tasks and providing log information including at least a respective status of the task. Respective processors may be located at a plurality of locations and a log accumulator may accumulate log information and may determine whether respective processors are operating successfully. The display may include location, task and processor icons corresponding to the plurality of tasks and processors and configured to indicate when respective one or ones of locations, tasks and/or processors are operating successfully, and a selector for selecting a respective one of the location, task or processor icons to display detailed log information for the selected location, detailed log information for the selected task or detailed log information for the selected processor, the detailed log information about each location being log information for tasks operating on each processor at the selected location, the detailed log information about each processor being log information for each task operating on the selected processor.

The invention may be further embodied as a monitoring system or a method for monitoring operation of resources. The resources may include a plurality loggers. The system may include a plurality of loggers for logging log information of transactions for each processor in a respective log, a plurality of log senders for automatically sending the log information from respective loggers, a log accumulator for accumulating the log information from respective log senders, and a monitoring station or a plurality of monitoring stations for receiving and displaying the accumulated log information.

### BRIEF DESCRIPTION OF THE DRAWINGS

The invention is best understood from the following detailed description when read in connection with the accompanying drawings. It is emphasized that, according to common practice, various features/elements of the drawings may not be drawn to scale. On the contrary, the dimensions of the various features/elements may be arbitrarily expanded or reduced for clarity. Moreover in the drawings, common numerical references are used to represent like features/elements. Included in the drawings are the following figures:

FIG. 1 is a schematic diagram of a monitoring system in accordance with an exemplary embodiment of the present invention;

FIG. 2 is a schematic diagram of a monitoring system in accordance with another exemplary embodiment of the present invention;

FIG. 3 is a graphic representation illustrating an exemplary formatted log in accordance with another exemplary embodiment of the present invention; and

FIG. 4 is a view illustrating a display of the monitoring station in accordance with another exemplary embodiment of the present invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Although the present invention is described in terms of a monitoring system for monitoring operations of network resources, the present invention may be applied to other systems, for example distributed systems, and other resources for example non-networked resources. It is contemplated that embodiments of the present invention may be applicable generally to monitoring of end-point devices, for example, secured end-point devices, such as automated teller machines (ATMs) or point-of-sale machines (PSMs), among others. In such systems, a common format of the data stream to a monitoring station allows for location monitoring, task monitoring and condition/state monitoring at each node (e.g., each end-point, task, communication, states or condition) being monitored. That is, a node may be: (1) a task executed on a processor including, for example, a communication; (2) a state of the processor, or (3) any other condition for which a log may be recorded, among others.

Each processor may perform a plurality of reconfigurable tasks and may provided log information including at least a respective status of the task. For example, in an archival system the reconfigureable task may include (1) load balancing; (2) sending query requests; (3) replying to queries; (4) sending logs; (5) receiving logs; (6) sending audit requests; (7) replying to audit requests; (8) sending files to store; and (9) receiving files to store, among others. It is understood that many other task are possible depending on the objective of the system being monitored.

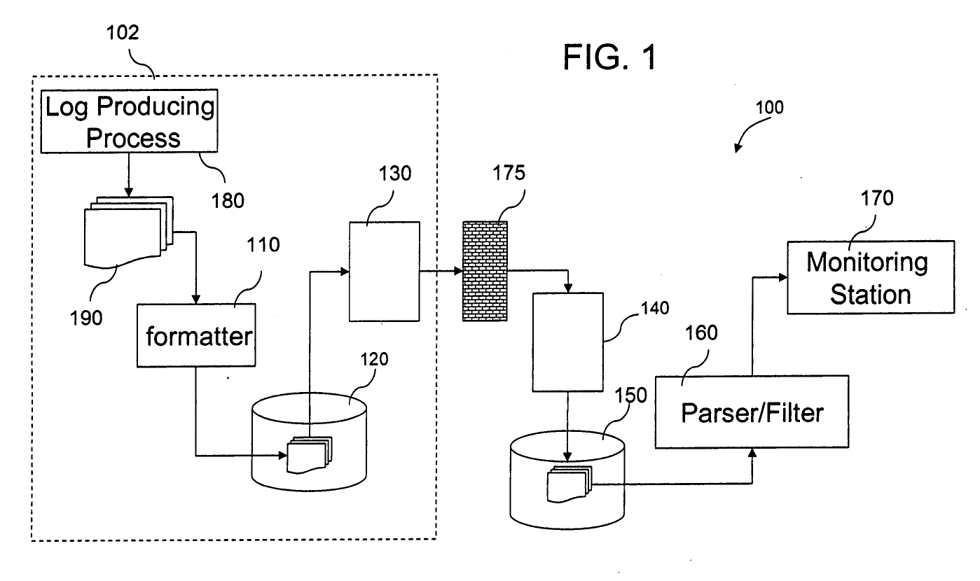

FIG. 1 is a schematic diagram of a monitoring system 100 in accordance with an exemplary embodiment of the present invention.

Referring now to FIG. 1, monitoring system 100 includes a common formatter 110, sender log files and/or a sender log database 120, a log sender 130, a log receiver 140, receiver log files and/or receiver a log database 150, a parser/filter 160 and a monitoring station 170. Logs are generated by a log producing process 180 based on a condition, a state of a network resource or a task status. The logs are recorded in a computer readable media 190, for example, as log files or as a log database. The log information in log files 190 may be read by a common formatter 110 and a portion or all of the information in log files 190 may be formatted in a common format by common formatter 110. That is, a common format may be established for use in monitoring by monitoring station 170. The log producing process 180 may also produce a log consistent with the common format (i.e., it may incorporate the common formatting operation internally).

These logs in the common format may be stored in sender log files and/or sender log database 120 as a persistent copy. Log sender 130 may retrieve the logs in the common format and may send the logs as a data stream to log receiver 140 via a firewall 175. Each log sender 130 may send log information automatically to a user-settable IP address for receipt by a corresponding log receiver 140. Each log receiver 140 may store a persistent copy of the data stream including the log information to receiver log files and/or receiver log database 150. Parser/filter 160 may retrieve the log information in the common format and parser and/or filter the log information, for example, for audio and/or visual display at monitoring station 170. That is, reception of the log information or accumulated log information by monitoring station 170 may occur automatically without any polling of the plurality of log senders 130 via a socket communication.

Log producing process 180 may be any log process which generates information to be monitored. For example, logs may be produced to monitor the state of a processor or other resource, to monitor completion or non-completion of a task or to monitor the occurrence or non-occurrence of a particular condition (for example, any number of monitored tasks and/or monitored states may define the particular condition).

Although monitoring system 100 is illustrated as having separate elements for log producing process 180, log files or log database 190, common formatter 110, sender log files and/or sender log database 120, log sender 130, log receiver 140, receiver log files and/or receiver log database 150, parser/filter 160 and monitoring station 170, these elements may be nodes on one or more processors such that each processor may be, for example, a computer and/or may have network functionality.

Monitoring system 100 is illustrated as having log producing process 180, log files or log database 190, common formatter 110, sender log files and/or sender log database 120, and log sender 130 on a common network 102, for example, a hospital network with firewall 175 providing security to the common network 102. It is understood that these elements may not be on a common network 102 and that firewall 175 may be optional. It is further understood that it is possible to encrypt data streams and/or data files/databases to secure the log information therein.

Log senders 130 and log receivers 140 are configurable to allow communication through firewall 175. That is, for example, protocols and ports of log sender 130 and log receivers 140 are desirably configurable to work with firewall 175 so that data streams including log information may be communicated via firewall 175 between respective log senders 130 and log receivers 140 without firewall 175 blocking such data streams.

Logs in the common format may include delimiters such that parser/filter 160 may separate (i.e., parse) data into fields by the delimiters. For example, each field in the log file (or data stream corresponding thereto) may be semicolon delimited or coma delimited, among others. By providing delimiters that are recognizable/parsable by standard word processing, spreadsheet and database applications, log information may be direct ported to such applications for analysis of system conditions. It is desirable to select a delimiter that is not used as characters in the log information.

Parser/filter may receive log information from receiver log file or receiver log database 150 and may process the information by filtering information not selected either based on predetermined rules or, otherwise, by user commands input to monitoring station 170. Monitoring station 170 may include an audio/visual display for audio and/or visual display of the filtered log information. For example, certain failure of the system being monitored may trigger an audible alarm to alert an operator to view a visual display of the details of such a failure or may trigger an e-mail or other notification such, as a page, automatically to operations personnel.

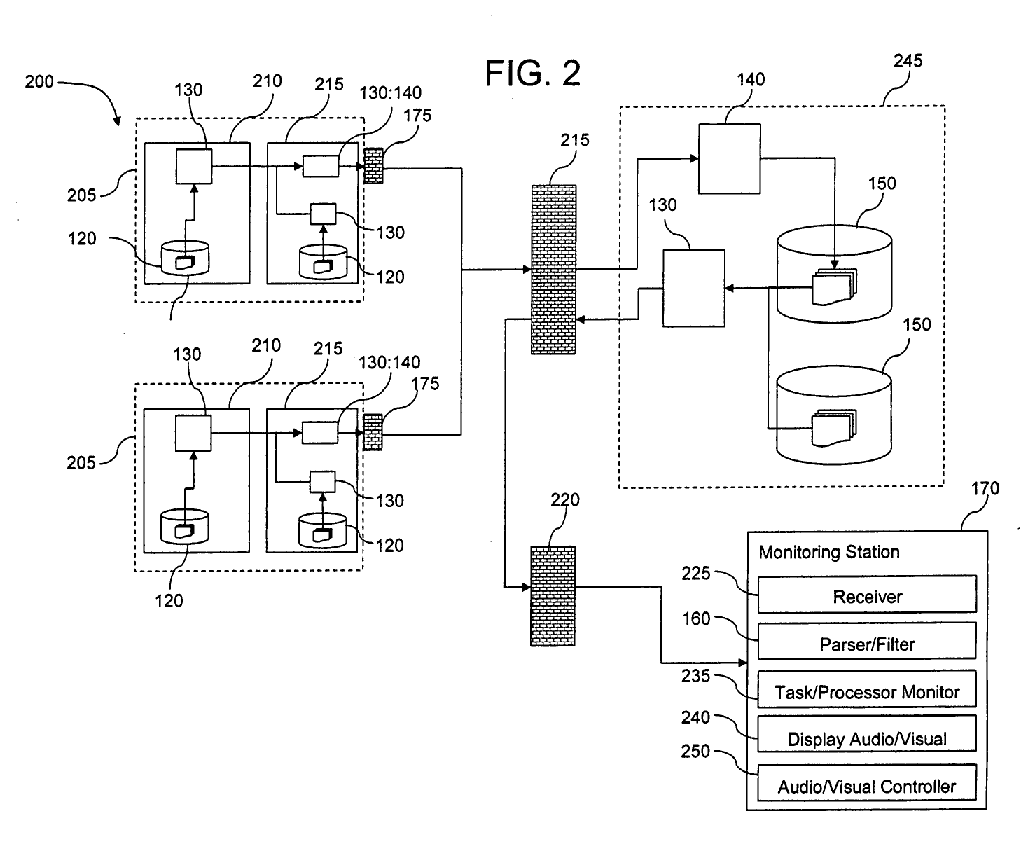

FIG. 2 is a schematic diagram of a monitoring system in accordance with another exemplary embodiment of the present invention.

Referring now to FIG. 2, monitoring system 200 may include monitoring of operations of a plurality of resources 150, 210, and 215 on a plurality of networks 205 and 245. Sender log files and/or sender log database 120, log sender 130, log receiver 140, receiver log files and/or receiver log database 150, parser/filter 160 and monitoring station 170 included in this exemplary embodiment are either omitted or only briefly described for brevity, since their functions are identical to that described in FIG. 1. Although common formatter 110 is not illustrated in FIG. 2, a plurality of common formatter 110 may be used to format log information for each sender log file or sender log database 120. Each common formatter 110 may format log information for a respective sender log file or sender log database 120 or for a plurality of sender log files or sender log databases 120 on a common network resource, for example, network resource 150, 210 or 215.

Each log receiver 140 may receive a plurality of data streams corresponding to the log information in a plurality of sender log files or sender log databases 120 and may aggregate the log information into an aggregated data stream. The aggregated data stream may include, for example, a first data stream received by a first log sender 130 and a second or subsequent data streams received from one or more other log senders 130. For example, by appending subsequently sent log information to previously sent log information, any number of log files/databases may be aggregated from any number of log senders 130. The aggregated log information may be sent via log receiver/sender 130:140 from network 205 secured by firewall 175, for example, to log receiver 140 at an external archive 245. Log information in the data stream from a plurality of networks 205 and 245 may be aggregated by log sender 130 at external archive 245 and a persistent copy may be store in log files or a log database 150 at external archive 245.

Logs may also be generated at external archive 245 to monitor operation of network resources at external archive 245, for example, to monitor operation by location, by condition, by task status and/or by state of the network resources.

Such log information may be aggregated with other respective log information, for example, at log sender 130 of external archive 245 and sent via a secure firewall structure 215:220 to monitoring station 170. That is, a portion of log receivers 140 may receive log information from respective log senders 130 such that data streams to such log receivers 140 from each respective log sender 140 is aggregated.

It is understood that by structuring the logging operation with log senders 130 and log receivers/aggregators 140, the monitoring operation of network resources is scalable to any number of network resources and the monitoring of network resources may be easily reconfigured by changing, for example, an IP address of a particular log sender 130 to a different log receiver 140 for aggregation. That is, since the monitoring operation is a fully parallel processing operation, it may be easily reconfigured.

Monitoring station 170 may include a receiver 225 to receive the data stream corresponding to the log information for monitoring. Receiver 225 may store the aggregated data stream received from external archive 245 in a storage device (not shown). Parser/filter 160 may parse (i.e., separate records and fields of respective records) of the log information of the data stream to process this log information for audio-visual display. Monitoring station 170 may be configured to display selected, aggregated (e.g., accumulated) log information, responsive to user commands.

The task/processor monitor 235 may be responsive to user commands from, for example, a computer terminal and may provide instructions to parser/filter 160 for filtering the aggregated data stream for audio and/or visual display. That is, for example, a user may select one or more tasks, conditions, and/or states to display audibly and/or visually on monitoring station 170. Moreover, task/processor monitor 235 may also continuously monitor for alarm/threshold conditions that may be automatically displayed audibly and/or visually or may initiate other notification methods, such as an e-mailing or a page based on monitoring rules. For example, if logs from a respective location are not received over a predetermined period, an audible alarm may sound and the graphical user interface (GUI) may indicate by one or more icons that network resources at that location are inactive (e.g., may not be operating properly).

Monitoring station 170 may flag inactivity in the log information being received from a respective processor or a respective task and may display an error condition for the respective processor or the respective task. Further, monitoring station 170 may flag activity in the log information being received from a respective processor or a respective task and may display the respective processor or respective task as showing real-time operation thereof.

According to another exemplary embodiment, task/processor monitor 235 may monitor the status indicator in each log having a common format or respective logs associated with tasks from each processor to determine whether the operation associated with each log or the operation associated with each task log has been successfully completed.

Audio-visual display 240 may receive parsed and/or filtered log information processed by audio-visual controller 250 for display. That is, for example, monitoring station 170 may display completion information from task/processor monitor 235 that indicates either successful or unsuccessful completion of a respective one or respective ones of the tasks being performed.

Although the monitoring station 170 is illustrated with a display 240, it is contemplated that the monitoring station 170 may operate without a display and may send alarms to other devices used, for example, by operations personnel.

Although display 240 is illustrated to be an audio-visual display, it is contemplated that the display may be either an audio display or a visual display.

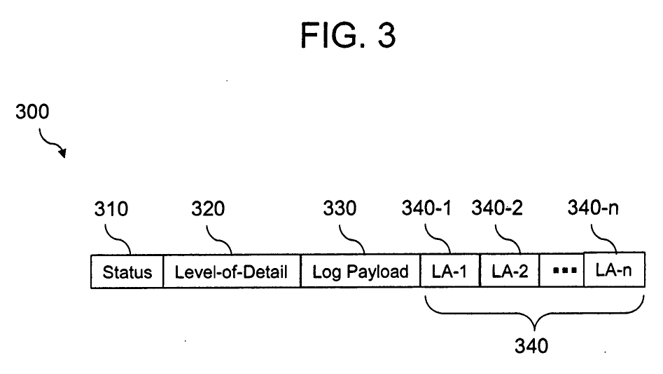

FIG. 3 is a graphic representation 300 illustrates common formatting of logs by a respective common formatter 110.

Now referring to FIG. 3, graphic representation 300 may include fields common to logs output by common formatter 110. The common fields include a status field 310, a level-of-detail field 320, a log payload field 330 and log attribute fields 340-1, 340-2 . . . 340-n. For example, log attribute fields 340-1, 340-2 . . . 340-n may include (1) one or more location fields (e.g., network or physical addresses) indicating the location from which the log is generated; (b) one or more machine fields indicating a machine or portion of a machine from which the log is generated; (3) one or more processor field indicating a processor from which the log is generated; a process field indicating a process from which the log is generated; (4) a sub-process field indicating a sub-process from which the log is generated; and (5) a timestamp indicating the time the log is generated, among others. Log attributes 340-1, 340-2 . . . 340-n enable drill down (i.e., filtering) by the parser/filter 160 of the log information and display thereof.

By selecting certain log payload information to be displayed, automatically, or by user commands, based on log attributes 340-1, 340-2, . . . 340-n, operation of corresponding network resources may be viewed, for example, according to the selected log attributes (or combination of log attributes). Automatic selection of log attributes may be based on triggering events such as a failure status in status field 310 or other alarm conditions such as resource loading conditions that are higher than a threshold level, among others.

Status field 310 indicates success or failure of the process, sub-process, task, condition or state being monitored. Level-of-detail field 320 indicates the level-of-detail in payload field 330 of the log. That is, as the level-of-detail in a log increases, level-of detail field 320 has, for example, a higher number therein to indicate more detail in payload field 330 relative to a lower detail log payload field 330.

For example, a lower level-of-detail indicator may be assigned to level-of-detail field 320 when log payload field 330 indicates only that a reading error occurred, while a higher level-of-detail indicator may be assigned to level-of-detail field 320, when a log is generated for the same reading error condition and the log payload corresponding thereto indicates, for example, not only a reading error but also the particular file name of the file being read that generated the reading error. When a log is generated for the same reading error condition, an even higher level-of-detail may be assigned to a log payload indicating the reading error is from the particular file and the number of retries associated with the retry process. Thus, the level of detail indicator in level-of-detail field 320 is hierarchical, indicating less information in payload field 330 at low levels-of-detail and increased detail as the level-of-detail indicator increases.

Since the log information may include a hierarchy of payload information that provides a plurality of levels-of-detail, monitoring station 170 may indicate one level of the plurality of levels-of-detail according to a settable level-of-detail indicator. In one exemplary embodiment, when monitoring station 170 indicates unsuccessful completion of a task being performed, the level-of-detail indicator is automatically changed to provide more detailed log information than that of the successful completion of the same task. In another exemplary embodiment, when monitoring station 170 indicates a failure condition and/or a failed task, the monitoring station 170 automatically provides the most detailed status information (e.g., filtered payload information) of the hierarchy of status information.

By structuring the common format with level-of-detail field 320 including the level-of-detail indicator and log attributes 340-1, 340-2 . . . 340-n, it is understood that logs corresponding to any network resource (i.e., processors, sub-processors, processes, sub-processes, tasks, states, and/or conditions) being monitored may be filtered, and the log information from such filtering represents hierarchically detailed information about the network resource that may be used for accessing proper operation of the network resource.

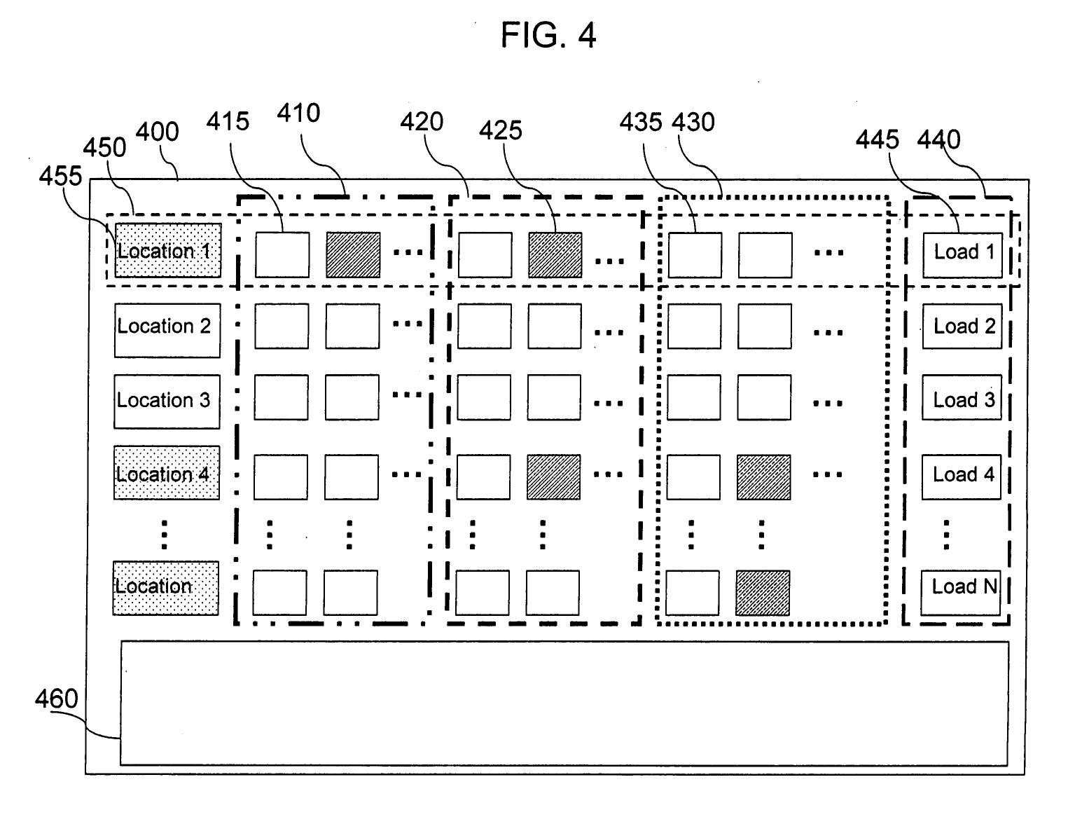

FIG. 4 is a view illustrating an exemplary display of the monitoring station 170.

Now referring to FIG. 4, the display (e.g., GUI) may include location icons 455, processor icons 415, task icons 425, condition icons 435, display indicators 445 and one or more viewing windows 460. Each task may represent a process or sub-process being monitored for successful completion. Each condition may represent a state of a processor or sub-processor or any other predetermined trigger event or events to be monitored, for example, processor loading above a threshold, unused memory below a certain threshold or failures of tasks above a particular threshold for certain locations or certain processors, among many others. A condition may include success or failure of a task or a group of tasks in combination with, for example, a state or states of certain processors. A location may include, for example, corresponding processors, tasks, conditions and/or display indicators associated with the location. Each processor icon 415 is a graphical representation of a processor or a group of processors being monitored. Each task icon 425 is a graphical representation of a task or a group of tasks being monitored. Each condition icon 435 is a graphical representation of a condition or a group of conditions being monitored. Each location icon 455 is a graphical representation of a location or group of locations being monitored.

It is understood drill-downs (i.e., filtering and displaying) of the log information may be provided, according to user commands issued at monitoring station 170. For example, log information for a location may be filtered to a show processor/sub-processor, task or condition log information related to the location according to selection of the associated icons 415, 425, or 435. A drill-down operation (i.e., a filter and display operation) may also be used to drill further down by selecting any processor or sub-processor icons 415, any task icons 425, any condition icons 435 and any display indicators 445. That is, by filtering log attribute 340-1, 340-2 . . . 340-n, a user may display, via an audio\visual display, the selected processor or sub-processor icons 415, task icons 425, condition icons 435, which enables viewing of the status of all or any portion of the network resources for any conditions, states and/or tasks being logged (e.g., monitored).

In a further exemplary embodiment, processor icons 415, task icons 425, condition icons 435, and display indicators 445 for a location and corresponding location icon 455 are viewable on one line 450 of a matrix such that a visual of a location may be presented to a user of monitoring station 170. Further, processor icons 415, task icons 425, condition icons 435 and display indicators 445 may be grouped into columns such that, for example, related processors (processors performing related operation (e.g., load balancing operations), related tasks, related conditions being monitored and related display indicators may also be easily viewed by the user for comparison therebetween. Processor icons 415 may be grouped in a processor area 410, task icons 425 may be grouped in a task area 420, condition icons 435 may be grouped in a condition area 430, and display indicators 445 may be grouped in a display indicator area 440.

In another exemplary embodiment, location, task and processor icons 455, 425 and 415 corresponding to the plurality of tasks and processors are provided in the display of monitoring station 170. These icons 455, 425 and 415 are configured to indicate when respective one or ones of locations, tasks and/or processors are operating successfully. A selector (for example, an input device such as a mouse, not shown) may be provided to select a respective one of the locations, tasks or processors icons 455, 425, or 415 to display detailed log information for the selected location, detailed log information for the selected task or detailed log information for the selected processor. The detailed log information about each location is log information for tasks operating on each processor at the selected location and the detailed log information about the processor is log information for each task operating on the selected processor.

One or more viewing windows 460 may be provided to view the filtered log information. Location, processor, tasks and condition icons 455, 415, 425 and 435 may be color-coded based on the respective status of each corresponding task. Each of these icons 455, 415, 425 and 435 may be (1) momentarily colored a first color, for example green, to indicate successful completion of the task; (2) momentarily colored a second color, for example red, to indicate unsuccessful completion of the task; (3) colored a third color, for example yellow, to indicate inactivity of the task; and/or (4) momentarily colored a fourth color, for example blue, to indicate activity within a past user-configurable time window.

Viewing windows 460 may be used to display the log information filtered (e.g., selected), for example, by clicking the location on the display of a respective icon 415, 425, 435, 445 or 455. That is, for example: (1) log information associated with a particular location may be displayed by clicking on the corresponding location icon 455; (2) log information associated with a particular processor may be displayed by clicking on a corresponding processor icon 415; (3) log information associated with a particular task may be displayed by clicking on the corresponding task icon 425; and (4) log information associated with a particular condition may be displayed by clicking on the corresponding condition icon 435. That is, the common format of each log may include log attributes for viewing log information representative of (1) a common location; (2) a common resource, (3) a common sub-process; (4) a common task; (5) a common failure condition; and/or (6) a common state.

A hierarchical level-of-detail indicator (not shown) may be set to automatically display log information in viewing windows 460 according to display rules. For example, the display rules may be that log information at the user defined level-of-detail set is displayed or that the level-of-detail set may be displayed along with all logs having a status field indicator indicating unsuccessful operation. Moreover, display rules may be set such that all such unsuccessful operations are displayed in viewing window 460 and, cannot be filtered either by the user or by monitoring station 170, to ensure that logs indicating failures are addressed.

Common formatter 110 may format associated logs to include at least a hierarchical information structure in which each associated log has a different level-of-detail with respect to a transaction (i.e., a log producing event) such that log information having different levels-of-detail are displayable by the monitoring station 170 based on the hierarchical level-of-detail indicator in the common format.

Although it is illustrated that the log information from networks 205 are routed from the networks 205 to monitoring station 170 via external archive 245, it is contemplated that the log information may be, otherwise, directly routed to monitoring station 170 to reduce or eliminate down-time due to communication channel failures between networks 205 and external archive 245.

Although the invention has been described in terms of a monitoring system, it is contemplated that the invention may be implemented in software on microprocessors/general purpose computers (not shown). In this embodiment, one or more of the functions of the various components may be implemented in software that controls the general purpose computer. This software may be embodied in a computer readable carrier, for example, a magnetic or optical disk, a memory-card or an audio frequency, radio-frequency, or optical carrier wave.

What is claimed:

1. A monitoring system for monitoring operation of resources, the resources including a plurality of processors, respective processors each performing a plurality of reconfigurable tasks and providing log information including at least a respective status of the task, the system comprising:
a plurality of log senders for sending the log information from respective nodes, each node being either one of the processors, or an instance on one of the processors executing a respective task;
a plurality of log receivers for receiving the log information from respective log senders;
one or more task monitors for monitoring the status of respective tasks from each processor via the plurality of log receivers to determine at least whether the respective tasks are successfully completed; and
a monitoring station for displaying completion information from the one or more task monitors that indicates either successful or unsuccessful completion of a respective one or respective ones of the tasks being performed.

2. The monitoring system according to claim 1, wherein a portion of the log receivers receive log information from respective log senders such that data streams to a log receiver from each respective log senders are aggregated.

3. The monitoring system according to claim 1, wherein the monitoring station further displays operational conditions of respective processors.

4. The monitoring system according to claim 1, wherein the monitoring station flags inactivity in the log information being received from a respective processor or a respective task and displays an error condition for the respective processor or the respective task.

5. The monitoring system according to claim 1, wherein the monitoring station flags activity in the log information being received from a respective processor or a respective task and displays the respective processor or respective task as showing real-time operation thereof.

6. The monitoring system according to claim 1, wherein the monitoring station includes a storage device for storing accumulated log information such that the monitoring station is configured to display selected accumulated log information, responsive to user commands.

7. The monitoring system according to claim 1, wherein the display of the monitoring station includes icons for selection of the accumulated log information according to a processor, a sub-process, and/or a tasks.

8. The monitoring system according to claim 1, wherein each task is reconfigurable among: (1) load balancing; (2) sending query requests; (3) replying to queries; (4) sending logs; (5) receiving logs; (6) sending audit requests; (7) replying to audit requests; (8) sending file to store; and (9) receiving files to store.

9. The monitoring system according to claim 1, wherein each log sender sends log information automatically to a user settable IP address.

10. The monitoring system according to claim 1, wherein the log information further includes a hierarchy of status information which provides a plurality of levels of detail, the monitoring station indicating one level of the plurality of levels of detail according to a settable level-of-detail indicator.

11. The monitoring system according to claim 10, wherein when the monitoring station indicates the unsuccessful completion of the task being performed, the level-of-detail indicator is automatically changed to provide more detailed log information than that of the successful completion of the same task.

12. The monitoring system according to claim 10, wherein when the monitoring station indicates a failure condition and/or a failed task, the monitoring station automatically provides the most detailed status information of the hierarchy of status information.

13. A monitoring system for monitoring operation of resources, the resources including a plurality of processors, respective processors having logs that include different log formats, the system comprising:
a plurality of loggers for logging log information of each transaction in a respective one or ones of the logs, each transaction being a completion of a task and/or a condition to be monitored;
a log formatter for formatting the respective one or ones of the logs for each processor into a common format;
a log accumulator for accumulating logs from respective processors; and
a monitoring station for receiving logs in the common format and displaying the log information therein.

14. The monitoring system according to claim 13, wherein:
the common format includes a hierarchical level-of-detail indicator; and
the monitoring station displays the log information according to the hierarchical level-of-detail selected.

15. The monitoring system according to claim 14, wherein the log formatter formats associated logs to include at least a hierarchical information structure in which each associated log has a different level-of detail with respect to a transaction such that log information having different levels-of-detail are displayable by the monitoring station based on the hierarchical level-of-detail indicator in the common format.

16. The monitoring system according to claim 14, wherein the common format of each log includes log attribute information for viewing log information representative of (1) a common location; (2) a common resource, (3) a common sub-process; (4) a common task; (5) a common failure condition; and/or (6) a common state.

17. The monitoring system according to claim 13, wherein the log accumulator includes a plurality of log senders and log receivers that aggregate data streams corresponding to the log information to one or more log files.

18. The monitoring system according to claim 13, wherein the common format includes field delimiters such that the accumulated logs are parsable by word processing and/or database applications.

19. A display for monitoring operation of resources, the resources including a plurality of processors, respective processors each performing a plurality of reconfigurable tasks and providing log information including at least a respective status of the task, respective processors being located at a plurality of locations, a log accumulator that accumulates log information and determines whether respective processors are operating successfully, the display comprising:
location, task and processor icons corresponding to the plurality of tasks and processors and configured to indicate when respective one or ones of locations, tasks and/or processors are operating successfully; and
a selector for selecting a respective one of the location, task or processor icons to display detailed log information for the selected location, detailed log information for the selected task or detailed log information for the selected processor, the detailed log information about each location being log information for tasks operating on each processor at the selected location, the detailed log information about each processor being log information for each task operating on the selected processor.

20. The display according to claim 19, wherein:
the monitoring system includes a parser to filter the log information from the plurality of processors according to user selection; and
the display further includes a viewing window for viewing the filtered log information.

21. The display according to claim 19, wherein the task and processor icons are color-coded based on the respective status of each corresponding task.

22. The display according to claim 19, wherein the task and processor icons are: (1) momentarily colored a first color to indicate successful completion of each corresponding task; (2) momentarily colored a second color to indicate unsuccessful completion of any corresponding task; (3) colored a third color to indicate inactivity of each corresponding task, (4) momentarily colored in a fourth color the task and processor icons to indicate activity of a corresponding task within a user-configurable time window, where the first, second, third and fourth colors are different colors.

23. A monitoring system for monitoring operation of resources, the resources including a plurality of processors, the system comprising:
a plurality of loggers for logging log information of transactions for each processor in a respective log;
a plurality of log senders for automatically sending the log information from respective loggers;
a log accumulator for accumulating the log information from respective log senders; and
a monitoring station for receiving and displaying the accumulated log information.

24. The monitoring system according to claim 23, wherein the reception of the accumulated log information by the monitoring station occurs automatically without any polling of the plurality of log senders via a socket communication.

25. The monitoring system according to claim 23, wherein the log accumulator includes a plurality of log senders and log receivers that aggregate data streams corresponding to the log information to one or more log files.

26. A method of monitoring operation of resources, the resources including a plurality of processors, respective processors each performing a plurality of reconfigurable tasks and providing log information including at least a respective status of the task, the method comprising the steps of:
a) sending the log information from respective nodes, each node being either one of the processors or an instance on one of the processors executing a respective task;
b) receiving the log information from the respective nodes;
c) monitoring the status of respective tasks from each processor based on the log information received; and
d) determining at least whether the respective tasks are successfully completed.

27. The method according to claim 26. further comprising the step of:
e) displaying completion information that indicates either successful or unsuccessful completion of a respective one or respective ones of the tasks being performed.

28. The method according to claim 26, wherein step (a) of sending the log information comprises the step of sending log information automatically to a user-settable IP address.

29. The method according to claim 27, wherein the log information further includes a hierarchy of status information which provides a plurality of levels-of-detail, the step (e) of displaying completion information comprises the step of displaying completion information according to the a settable level-of-detail indicator.

30. The method according to claim 29, wherein when the monitoring station indicates the unsuccessful completion of the task being performed, automatically changing the level-of-detail indicator to provide more detailed log information than that of the successful completion of the same task.

31. A method of monitoring operation of resources, the resources including a plurality of processors, respective processors having logs that include different log formats, the method comprising the steps of:
a) logging log information of each transaction or state for each processor in a respective one or ones of the logs;
b) formatting the respective one or ones of the logs for each processor into a common format which includes a hierarchical level-of-detail indicator;
c) accumulating logs from respective processors;
d) setting a hierarchical level-of detail based on the hierarchical level-of-detail indicator in the logs that have the common format; and
e) displaying the log information therein according to a hierarchical level-of-detail set.

32. The method according to claim 31, wherein step (b) of formatting the respective one or ones of the logs for each processor comprises the step of: structuring the common format of the logs to include at least a hierarchical information structure in which more or less detailed log information is displayable based on the hierarchical level-of-detail selected.

33. The method according to claim 31, wherein step (c) of accumulating logs from respective processors comprises the step of aggregating data streams corresponding to the log information of a plurality of log senders to one or more log files.

34. A method of displaying operation of resources, the resources including a plurality of processors, respective processors each performing a plurality of reconfigurable tasks and providing log information including at least a respective status of the task, the method comprising the steps of:
a) determining whether respective locations, processors and tasks are operating successfully;
b) displaying location task and processor icons corresponding to the plurality of tasks and processors and configured to indicate when respective one or ones of tasks and processors are operating successfully; and
c) selecting a respective one of the location, task or processor icons to display detailed log information for the selected location, detailed log information for the selected task or detailed log information for the selected processor, the detailed log information about each location being log information for tasks operating on each processor at the selected location, the detailed log information about each processor being log information for each task operating on the selected processor.

35. The display according to claim 34, further comprising the steps of:
parsing the log information to filter the log information from the plurality of processors according to user selection; and
viewing the filtered log information when displaying detailed log information for the selected task.

36. The method according to claim 34, wherein step (b) of displaying task and processor icons comprises color-coding the location, task and processor icons based on the respective status of each corresponding task.

37. The method according to claim 36, wherein the color-coding of the task and processor icons includes: (1) momentarily coloring the task and processor icons a first color to indicate successful completion of each corresponding task; (2) momentarily coloring the task and processor icons a second color to indicate unsuccessful completion of any corresponding task; (3) coloring the task and processor icons a third color to indicate inactivity of each corresponding task, (4) momentarily coloring the task and processor icons in a fourth color the task and processor icons to indicate activity of a corresponding task within a user-configurable time window, where the first, second, third and fourth colors are different colors.

38. A method of monitoring operation of resources, the resources including a plurality of processors, the method comprising the steps of:
a) logging log information of transactions for each processor in a respective log;
b) automatically sending the log information for each transaction;
c) accumulating the log information from respective transactions; and
d) receiving and displaying the accumulated log information.

39. The method according to claim 38, wherein step (c) of accumulating the log information comprises the step of aggregating data streams corresponding to the log information from a plurality of transactions to one or more log files.

40. A computer readable carrier including software that is configured to control a computer to implement an monitoring method embodied in a computer readable medium for monitoring operation of resources, the resources including a plurality of processors, respective processors each performing a plurality of reconfigurable tasks and providing log information including at least a respective status of the task, the monitoring method including the steps of:
a) sending the log information from respective nodes, each node being either one of the processors or an instance on one of the processors executing a respective task;
b) receiving the log information from the respective nodes;
c) monitoring the status of respective tasks from each processor based on the log information received; and
d) determining at least whether the respective tasks are successfully completed.

41. A computer readable carrier including software that is configured to control a computer to implement a monitoring method embodied in a computer readable medium for monitoring operation of resources, the resources including a plurality of processors, respective processors having logs that include different log formats, the monitoring method including the steps of:
a) logging log information of each transaction for each processor in a respective one or ones of the logs;
b) formatting the respective one or ones of the logs for each processor into a common format which includes a hierarchical level-of-detail indicator;
c) accumulating logs from respective processors;
d) setting a hierarchical level-of detail based on the hierarchical level of detail indicator in the logs that have the common format; and
e) displaying the log information therein according to a hierarchical level-of-detail selected.
